(19) United States
(12) Patent Application Publication
(10) Pub. No.: US 2024/0260555 A1
(43) Pub. Date: Aug. 8, 2024

(54) Quick Change Fishing Bead

(71) Applicant: Joseph Mario Wrobel, Hillsboro, OR (US)

(72) Inventor: Joseph Mario Wrobel, Hillsboro, OR (US)

(21) Appl. No.: 18/165,944

(22) Filed: Feb. 8, 2023

(51) Int. Cl. A01K 85/00; A01K 85/01

(52) U.S. Cl. CPC A01K 85/1867; A01K 85/018

(57) ABSTRACT

Fishing beads designed to imitate fish eggs used as bait for catching fish. A bobber stopper is threaded onto the fishing line before a hook is tied. A hook is then tied to the end of the fishing line. After the fishing line is tied to the hook with a bobber stopper on the fishing line, the quick-change fishing bead is routed over the line through a spiral shaped gap, then pressed down onto the bobber stopper to securely hold the quick-change fishing bead onto the fishing line. The quick-change fishing bead is then able to be changed with other colors, sizes, and buoyancies multiple times without cutting the hook off the line.

### CROSS REFERENCE TO RELATED APPLICATIONS

This application claims priority to copending U.S. Application, Ser. No. 63/309,534, filed on Feb. 12, 2022, which is hereby incorporated by reference for all purposes.

### BACKGROUND

The present disclosure relates to fishing beads, which are used as bait to catch fish. A fishing bead, when used as bait, mimics a fish egg.

When fishing with beads as bait, it is desirable to position the bead directly on the fishing line one to two inches above the hook. When used like this, the fishing bead will not touch the hook. There are many ways to secure the fishing bead on the line to prevent the fishing bead from sliding away from the desired position on the line. In this design, a cylindrical bobber stopper is used to lock the fishing bead in place.

The problem this fishing bead design solves is it allows the fishing bead to be changed without cutting the fishing line. It is good practice to continually change fishing bead color and size until you find a color and size the fish will bite. With traditional fishing beads, the person fishing is reluctant to change the bead color often because it is a time-consuming hassle to continually retie the line after cutting. Also, with frequent cutting, the line will become successively shorter. With this design, the fishing bead can be changed within seconds and without cutting the fishing line.

There does exist soft beads made from rubber of silicone which can be changed without cutting the fishing line, however it is very challenging to get the soft bead to reliably stay in the desired place, one to two inches above the hook. When soft beads are attached after the hook is tied onto the fishing line, will often be positioned directly on the hook, not above the hook as desired.

### SUMMARY

The present disclosure is directed to fishing beads designed to imitate fish eggs used as bait for catching fish. A bobber stopper is threaded onto the fishing line before a hook is tied. A hook is then tied to the end of the fishing line. After the fishing line is tied to the hook with a bobber stopper on the fishing line, the quick-change fishing bead is routed over the line through a spiral shaped gap, then pressed down onto the bobber stopper to securely hold the quick-change fishing bead onto the fishing line. The quick-change fishing bead is then able to be changed with other colors, sizes, and buoyancies multiple times without cutting the hook off the line.

### BRIEF DESCRIPTION OF THE DRAWINGS

FIG. 1 is a side view of the quick-change fishing bead.

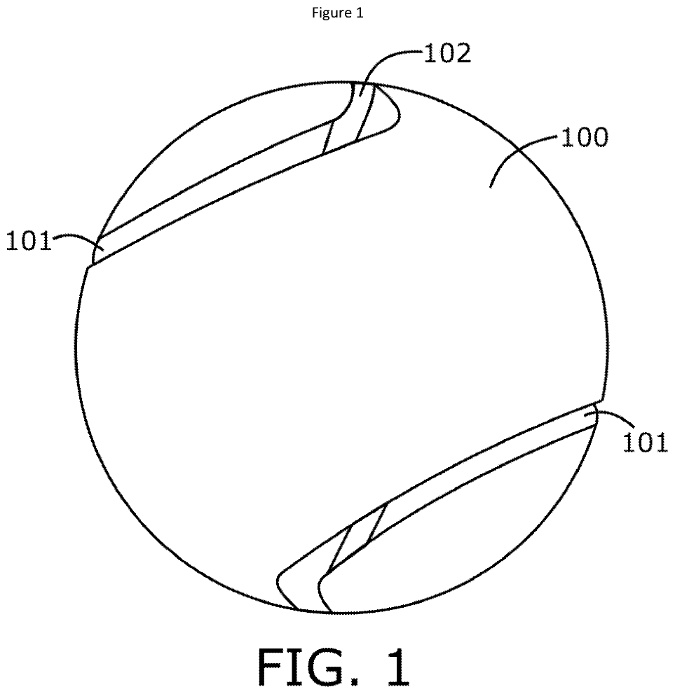

FIG. 2 is a top view of the quick-change fishing bead.

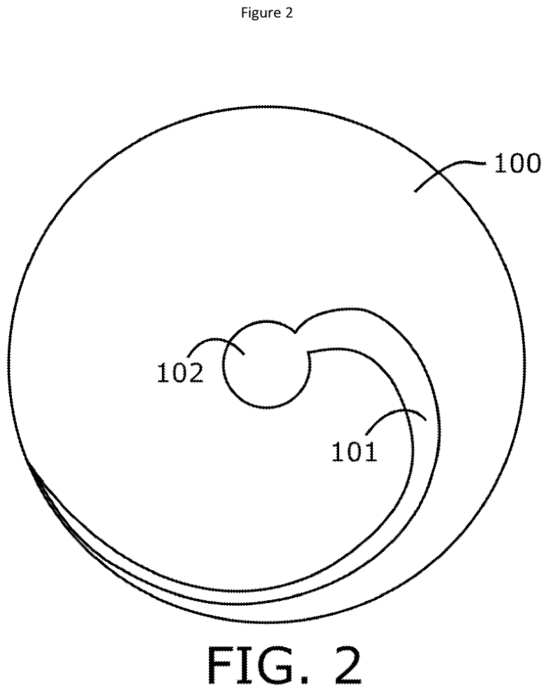

FIG. 3 is a perspective view with the top of the quick-change fishing bead tilted towards the viewer.

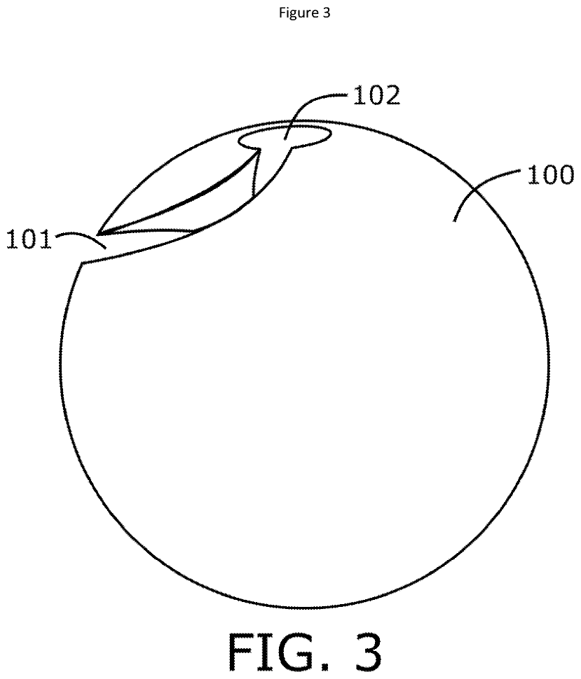

FIG. 4 is a side view of the quick-change fishing bead cut in half down the center to show the internal structure.

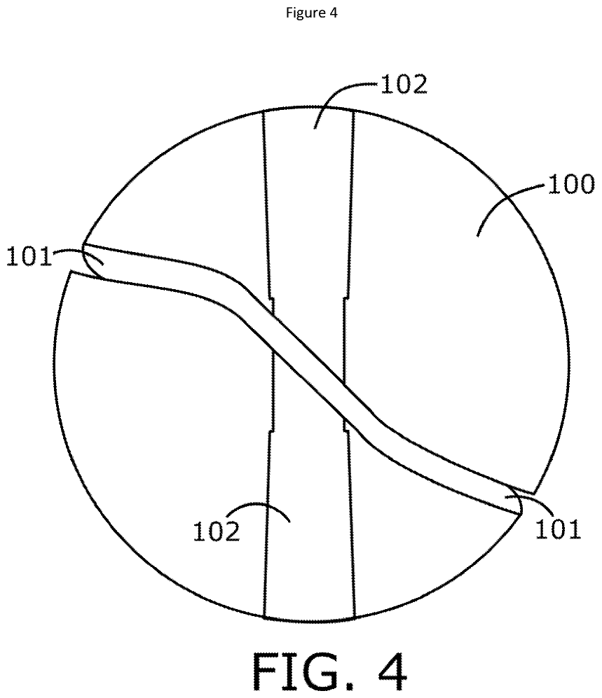

FIG. 5 is a perspective view of the quick-change fishing bead which has been turned on the side. This view shows the quick-change fishing bead as it is threaded onto a fishing line with a bobber stopper pressed into the shaft of the bead thus locking the bead onto the fishing line.

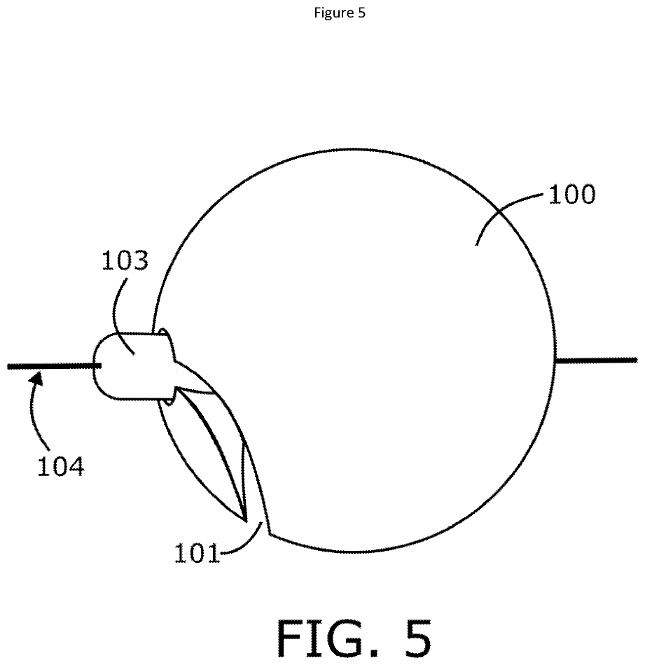

### DETAILED DESCRIPTION

The disclosed quick-change fishing bead will become better understood through the review of the following detailed description in conjunction with the figures. The detailed description and figures provided merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

### Quick-Change Fishing Bead

With reference to the figures, quick-change fishing beads will now be described. The quick-change fishing beads described herein function as bait to catch fish when used with a fishing pole with fishing line.

The reader will appreciate from the figures and description below that the presently disclosed quick-change fishing beads address some of the shortcomings of traditional fishing beads made from hard or soft materials.

The disclosed quick-change fishing beads detailed here may vary in size and color. The quick-change fishing bead makes use of a spiral gap 101 which wraps around the bead 100 from the top to the bottom. A spiral gap 101 is not possible to achieve with traditional manufacturing techniques.

The fishing beads may vary in weight and buoyancy. The bead 100 inner filling may be finely adjusted to control the buoyancy. By adjusting the inner filling, the bead 100 is able to float, sink, or maintain neutral buoyancy in the water column. Controlling the buoyancy in such a way is not possible with traditional bead manufacturing techniques.

The manufacturing process of this quick-change fishing bead 100 utilizes Fused Deposition Modeling (FDM) which is an additive manufacturing technology. With FDM, material is precisely deposited by machinery to build each fishing bead. The inner density of the fishing bead can be adjusted to determine if the fishing bead will float, sink, or hover in the water column when the fishing bead is used in any body of water.

The bead 100 can be round like other fishing beads, however, the spiral gap 101 will allow for a fishing line 104 to pass through the bead 100 body to rest in the center shaft 102 of the bead 100.

The spiral gap 101 also provides a way to apply fishing bait scent directly to the fishing bead. The fishing bait scent will stay on the fishing bead longer than what is possible with traditional fishing beads because the fishing scent will hold in place within the spiral gap without being quickly washed away.

The bead 100 will be able to slide freely along the fishing line 104 unless a bobber stopper 103 is used to lock the bead 100 in place.

The bobber stopper 103 can be inserted into the top bobber stopper shaft 102, the bottom bobber stopper shaft 102, or both bobber stopper shafts. There is no difference in function between the bobber stopper shaft 102 on the top or the bottom, however, the top and bottom shafts may have different diameters to accommodate variances of fishing line thickness.

The diameter of the bobber stopper shaft 102 is designed to provide a snug fit for the outer diameter off the bobber stopper 103. The bobber stopper shaft 102 must be finely adjusted to ensure the fit is snug. This snug fit is how the bead 100 will stay locked into place on the fishing line 104.

1. A fishing bead which can be shaped as a sphere or more complex shapes comprising:
a round hole through the center of the fishing bead which intersects all the way through from the top to the bottom of the fishing bead; a spiral shaped gap intersecting the round center hole and the outer wall of the fishing bead and the entire length of the fishing bead starting from the top hole all the way through the fishing bead to the bottom hole.

2. The fishing bead of claim 1, wherein the top and/or bottom hole(s) are sized with tight tolerances to compress the bobber stopper when the bobber stopper is pressed into the hole.

3. The fishing bead of claim 1, wherein the inner density can be adjusted to control the buoyancy of the fishing bead within the range from floating, neutral, and sinking buoyancies.

4. The fishing bead of claim 1, wherein the spiral shaped gap can be injected with fishing scent.
